(19) United States
(12) Patent Application Publication
(10) Pub. No.: US 2007/0116068 A1
(43) Pub. Date: May 24, 2007

(54) System and components for generating single-longitudinal-mode nanosecond laser beam having a wavelength in the range from 760nm to 790nm

(76) Inventor: Hong Wei Mao, Fremont, CA (US)

Correspondence Address: Hong Wei Mao, 362 Washington Blvd #4, Fremont, CA, 94539, US

(21) Appl. No.: 11/517,471

(22) Filed: Sep. 8, 2006

Related U.S. Application Data
(60) Provisional application No. 60/738,461, filed on Nov. 21, 2005.

(51) Int. Cl. H01S 3/11; H01S 3/10

(52) U.S. Cl. 372/10; 372/22

(57) ABSTRACT

A laser system and components for generating Single-Longitudinal-Mode (SLM) nanosecond laser beam having a wavelength in the range from 760 nm to 790 nm. The cavity of laser system comprising a front cavity mirror, an Erbium and Ytterbium irons co-doped or Erbium iron doped gain medium, a saturable absorber for passively Q-switching, an apparatus for polarization and longitudinal cavity mode selection, an intra-cavity frequency doubling crystal and an output dichromatic cavity mirror. The cavity is optically pumped by a diode Laser pump source.

This application claims the priority of provisional application #U.S. 60/738,461; filing date Nov. 21, 2005 (Title: System and a method for generating single-longitudinal-mode nanosecond NIR laser beam; Inventor: Mao, Hongwei)

### BACKGROUND OF THE INVENTION

The invention relates to a laser, in particular, to a compact Single-Longitudinal-Mode (SLM), Q-Switched Intra-cavity frequency doubled Laser having a wavelength range from 760 nm to 790 nm.

Wavelength stabilized and spectrum narrowed laser radiation at a wavelength range from 760 nm to 790 nm is extremely useful for numerous industrial and scientific applications ranging from drug screening, medical diagnosis, environmental chemical monitoring, to biology studies. It is the major laser source for Raman spectroscope, and Raman microscope.

So far, there are several ways to produce spectrum narrowed laser radiation in this wavelength range. In one conventional approach, the output of diode laser is wavelength stabilized and narrowed by external cavity feedback. S. B. Bayram and T. E. Chupp disclosed such a laser in Review of Scientific Instruments Vol. 73, No. 12, (2002); p 4169-4171; George Anthony Rakuljic disclosed another laser using similar technique in U.S. Pat. No. 5,691,989; This type of lasers operate in a continue wave mode. However, in many applications, especially for Raman study in a live biology specimens and human body, it is better to use a high peak power but low average power pulse laser as a pumping source, to increase Raman signal intensity without causing thermal damage to live specimens which is vital for medical diagnosis and biology studies.

K. W. Kangas et. al. disclosed in Laser '88; Proceedings of the International Conference, Lake Tahoe, Nev., Dec. 4-9, 1988 (A90-30956 12-36). McLean, Va., STS Press, 1989 (p 444-448), a SLM nanosecond laser pulse having a wavelength range from 760 nm to 790 nm generated by Ti: Sapphire laser. However the system in this approach is complex and high cost. Conventionally the Ti: Sapphire laser is pumped by a green laser which is a bulky and costly laser system. In an alternative approach, W. R. Bosenberg and D. R Guyer disclosed in an article published in Appl. Phys. Lett. 61 (4) 27 (1992) (p 387-389) a Single-longitudinal-mode nanosecond pulse having a wavelength range from 760 nm to 790 nm generated by KTP optical parametric oscillator pumped at 532 nm. Again, the system is very complex and costly. N. D. Lai, et. al. disclosed a different approach in an article entitled “Two-frequency Er—Yb:glass microchip laser passively Q switched by a Co:ASL saturable absorber”; Optics Letters, Vol. 28, No. 5 Mar. 1, 2003, p 328-330. A Single-Longitudinal-Mode 777 nm nanosecond laser pulse was produced via external frequency doubling of a Q switched Er: Yb: Glass microchip Laser in a 10-mm-long periodically poled LiNbO3 crystal. The conversion efficiency is very low in an external cavity frequency doubling approach. Therefore a high cost periodically poled LiNbO3 crystal is used.

On the other hand, Intra-cavity frequency doubled q-switched solid state laser is demonstrated to be a reliable compact laser system. Zarrabi et. al. disclosed in U.S. Pat. No. 5,388,114 an intra-cavity frequency doubled q-switched solid state laser generating short laser pulse at 532 nm and 266 nm. Laser pulses at these wavelengths are useful for Laser induced fluorescence studies. However it is not suitable for Raman studies in Biology due to large fluorescent background.

As none of the aforementioned approaches provides a low cost efficient way for producing short pulse narrow spectrum laser radiation in the wavelength range from 760 nm to 790 nm, there is still a need to provide low cost compact laser devices and systems that can efficiently generate nanosecond short laser pulse in a wavelength range from 760 nm to 790 nm by utilizing q-switching, intra-cavity frequency doubling techniques.

### SUMMARY OF THE INVENTION

It is therefore an aspect of the present invention to provide an improved laser system for generation of single-longitudinal mode short pulse laser beam in a wavelength range from 760 nm to 790 nm which is suitable for Raman studies in biology and medical applications. In order to generate narrow spectrum laser radiation in the wavelength range of 760 nm to 790 nm, Er: Yb or Er doped material is selected as the gain medium. The laser is oscillating at the fundamental wavelength corresponding to ⁴I_{13/2} to ⁴I_{15/2} laser transition in Er³⁺ ion having a wavelength within the range of 1520 nm to 1580 nm. The laser is Q-Switched and the fundamental wave is further frequency doubled within the laser cavity in a nonlinear optical frequency doubling crystal to generate laser beam in a wavelength range from 760 nm to 790 nm.

It is therefore another aspect of the present invention to provide an improved laser system for generation of single-longitudinal mode short pulse laser beam in a wavelength range from 760 nm to 790 nm by directly pumped with low cost, commercially available 970-980 nm diode laser. High power diode laser is a proven technology that provides reliable compact low cost pump source for fiber optical communication industry. The laser system disclosed in instant invention includes a diode laser lasing between 970-980 nm and a coupling means to couple the pump laser beam onto the Er: Yb or Er doped gain medium. In one embodiment the coupling means is a pair of lens and a dielectric mirror.

It is therefore another aspect of the present invention to provide an improved single-longitudinal mode laser cavity for generation of short pulse laser beam in a wavelength range from 760 nm to 790 nm. The laser cavity includes a Q-switching element for generation of short laser pulses, an intra-cavity optical frequency filter for single longitudinal mode selecting, a polarization selecting element to improve the stability of frequency doubling, and an intra-cavity frequency doubling element to convert laser radiation from fundamental wavelength to a range from 760 nm to 790 nm which is suitable for Raman studies in Biology and medical applications. Laser Q-switching, cavity longitudinal mode and polarization mode selection is realized in a highly integrated, reliable, and low cost optical means.

It is therefore another aspect of the present invention to provide one optical component with multiple functions for application in an improved single-longitudinal mode Q-switch intra-cavity frequency doubled laser system. The system design in this disclosure is featured with shortest technical path. The optical components in the embodiments of present invention are of multi-functions. In one embodiment a birefringence F-P Etalon made of odd order of quarter wave retardation plate provides the functions both for polarization and longitudinal mode selection. In another embodiment a F-P Etalon made of saturable absorber Co²⁺:MgAI₂O₄ crystal provides both the functions of longitudinal mode selection and Q-switching, and a nonlinear optical LiNbO₃ crystal of a small wedge on the direction that is not angular sensitive for phase-matching tuning provides both the functions of polarization selection and frequency doubling. In another embodiment a polarization dependent F-P Etalon made of a-cut Co²⁺:LaMgAl₁₁O₁₉ crystal provides the functions of polarization selection, longitudinal mode selection and Q-switch. Several critical functions provided by one cavity component reduces the number of components needed therefore provides a laser system that is more reliable, more compact and low cost. Intra-cavity frequency doubling in low cost bulk KTP or LiNbO3 crystals make it possible to get very high conversion efficiency at a very low cost.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and to the arrangements of these components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a Single-Longitudinal-Mode (SLM) Q-switched intra-cavity frequency doubled laser system having a wavelength in a range from 760 nm to 790 nm, in accordance with embodiment 1 of the invention.

FIG. 2 is a schematic diagram of embodiment 2, an alternative embodiment of laser system according to the invention.

FIG. 3 is a schematic illustration of embodiment 3, a compact laser system in accordance with yet another embodiment of the invention.

### DETAILED DESCRIPTION OF THE INVENTION

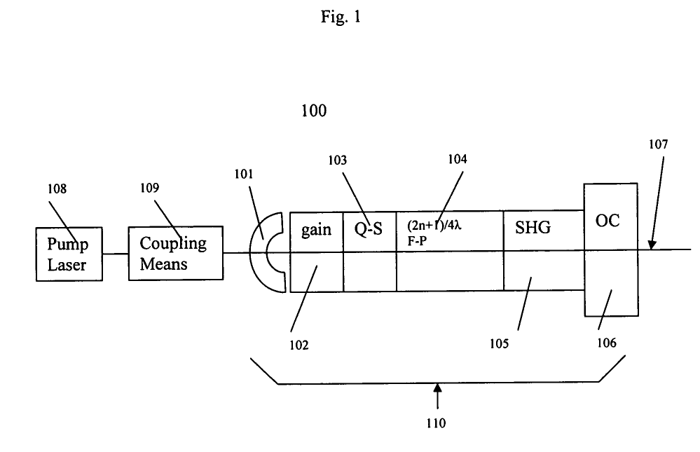

Referring to FIG. 1, there is shown a Single-Longitudinal-Mode (SLM), Q-switched, intra-cavity frequency doubled laser 100 having a wavelength in the range from 760 nm to 790 nm, in accordance with instant invention. Laser cavity 110 according to the invention comprises a front cavity mirror 101 which is highly transparent coated at 970 nm to 990 nm and highly reflective coated at 1520 nm to 1580 nm, a gain medium 102 which is Er:Yb: Glass (Yb: 22% wt; Er: 1% wt) for example that amplifying the laser radiation at fundamental wavelength in a range from 1520 nm to 1580 nm corresponding to ⁴I_{13/2} to ⁴I_{15/2} laser transition in Er³⁺ ion; a Q-Switch 103 either active or passive, preferably passive for example, such as Co²⁺:MgAl₂O₄ crystal; a birefringence Fabry-Perot Etalon 104 such as an uncoated birefringence phase retardation plate; an intra-cavity frequency doubling means 105 such as LiNbO₃ crystal which is configured to phase match for second harmonic generation; and an output cavity mirror 106 which is highly transparent coated at 760 nm to 790 nm and highly reflective coated at 1520 nm to 1580 nm. The gain medium 102, such as Er:Yb Glass is optically pumped by diode laser 108 through coupling means 109 and front mirror 101 so that there is sufficient population inversion built up inside the gain medium 102 for laser oscillation. The saturable absorber 103, Co²⁺:MgAl₂O₄ crystal for example, is used for passively Q-switching of laser oscillation at fundamental wavelength. The absorption coefficient of saturable absorber 103 at fundamental wavelength is inversely proportional to the laser power in the cavity.

The polarization modes and longitudinal mode within said laser cavity are selected by a birefringence Fabry-Perot Etalon 104. In a preferred embodiment, the birefringence Fabry-Perot Etalon 104 is an uncoated odd order ¼ wave quartz plate. In the preferred embodiment, the transmission peaks of said birefringence Fabry-Perot Etalon 104 for two orthogonal polarized light waves are shifted by 1/2 Free spectral range of said Etalon. The polarization mode and longitudinal mode within said laser cavity are selected by matching the transmission peak of birefringence Fabry-Perot Etalon 104 and gain curve with the wavelength of laser cavity mode via changing the optical path of birefringence Fabry-Perot Etalon 104. The optical path of Etalon 104 can be changed by tilting, or changing the setting temperature, for examples.

The fundamental laser beam is further intra-cavity frequency doubled by a nonlinear optical crystal 105 to generate coherent light beam having a wavelength range from 760 nm to 790 nm. Nonlinear optical crystal 105 may be a LiNbO₃ crystal, or a KTP crystal for examples. By placing the nonlinear optical crystal inside the laser cavity, the efficiency of frequency doubling is greatly improved. The frequency doubled laser beam is extracted from the cavity 110 through output mirror 106 that is coated to be highly reflective at fundamental wavelength and highly transparent at the second harmonic wavelength. Laser system 100 therefore provides a compact low cost Single-Longitudinal-Mode, Q-switched laser with wavelength in the range of 760-790 nm which is suitable for Raman studies in biology and medical applications. The optical components forming the laser cavity and the components inside the cavity may be combined or integrated to reduce the number of components needed or replaced with multi-function components assembled from multiple single-function components.

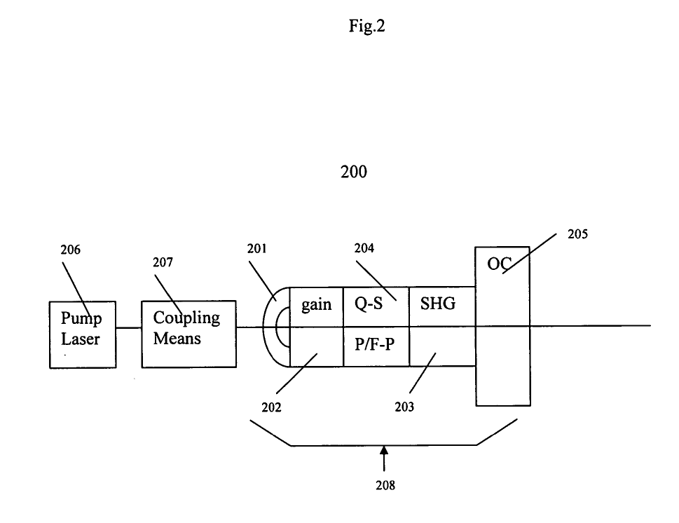

Referring to FIG. 2, there is shown an alternative embodiment of laser system 200 in accordance with instant invention. The laser cavity 208 in this embodiment is similar to the laser cavity 110 illustrated in FIG. 1, however, this embodiment differs in that the means for Q-switching, wavelength and polarization mode selection is a simple Fabry-Perot Etalon that is made of a polarization dependent saturable absorption crystal. In a preferred embodiment shown in FIG. 2, the polarization dependent saturable absorption crystal is, but not limited to, an a-cut Co²⁺:LaMgAl₁₁O₁₉ Crystal. The longitudinal mode of laser cavity is selected via Fabry-Perot Etalon effect in the uncoated a-cut Co²⁺:LaMgAl₁₁O₁₉ crystal.

The polarization mode of laser cavity is selected via anisotropy of the absorption in a-cut Co²⁺:LaMgAl₁₁O₁₉ crystal. The Co²⁺:LaMgAl₁₁O₁₉ crystal is also used for Q-switching due to its nonlinear absorption that is inversely proportional to the laser power at fundamental wavelength in the cavity. In laser system 200, Fabry-Perot Etalon 204 that is made of a polarization dependent saturable absorption crystal provides the functions of longitudinal mode selection, polarization mode selection and Q-switching. The use of one optical component with multiple functions provides the advantage of reducing the number of optical components needed for the system, therefore reduces the material cost, simplifies the cavity configuration and alignment process and improves the system stability.

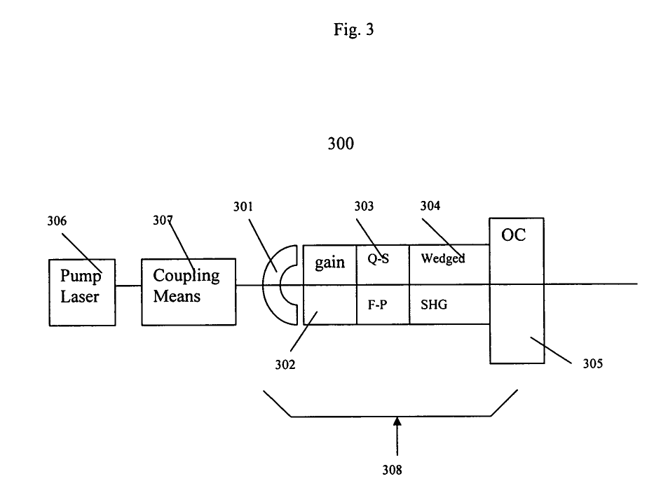

Referring to FIG. 3, there is shown a laser system 300 in accordance with yet another embodiment of the invention. The layout of laser cavity 308 in instant embodiment is similar to the laser cavity 208 illustrated in FIG. 2. However, in instant embodiment the Fabray-Perot Etalon 303 is made of isotropic saturable absorber crystal, instead of polarization dependent saturable absorber. The embodiment shown in FIG. 3 further differs from the one shown in FIG. 2, in the mechanism for polarization mode selection.

In a preferred embodiment of laser system shown in FIG. 3, isotropic saturable absorption crystal 303 is, but not limited to, Co²⁺:MgAl₂O₄ Crystal. The longitudinal mode of laser cavity 308 is selected via Fabry-Perot Etalon effect in the uncoated Co²⁺:MgAl₂O₄ crystal 303. The Co²⁺:MgAl₂O₄ crystal 303 is also used for Q-switching due to its nonlinear absorption.

In instant embodiment, the frequency of two orthogonal polarized laser cavity modes is shifted at least 25% and preferably by 50% of Free Spectral Range (FSR) of the cavity. Preferably, the shifting of frequency of two orthogonal polarized laser cavity modes is adjusted by moving the position of wedged frequency doubling crystal 304 laterally, without changing the phase matching condition for frequency doubling. The nonlinear frequency doubling crystal 304, LiNbO3 crystal for example, is of a small thickness variation that offering birefringence phase retardation adjustment. The polarization mode is selected by matching the cavity mode frequency with the peak of the net gain curve that is determined by gain curve and transmission curve of said Fabry-Perot Etalon 303. In laser system 300, Fabray-Perot Etalon 303 that is made of isotropic saturable absorber crystal provides the functions of longitudinal mode selection and Q-switching; wedged frequency doubling crystal 304 provides the functions of frequency doubling and polarization mode selection. The use of one optical element with multiple functions provides the advantage of reducing the number of optical components needed for the system, therefore reduces the material cost, simplifies the cavity configuration and alignment process and improves the system stability.

It should be understood, of course, that the foregoing relates to preferred embodiments of the invention and that modifications may be made without departing from the spirit and scope of the invention as set forth in the following claims.

I claim:

1. An optical system for generating single-longitudinal-mode nanosecond laser beam having a wavelength in the range from 760 nm to 790 nm comprising:
a pump laser;
a pump laser beam coupling optical means and;
an optical resonant cavity configured with at least two cavity mirrors, wherein said optical resonant cavity further comprising:
a gain medium whereas said pump laser beam coupling optical means couples an output from said pump laser onto said gain medium for laser radiation at a first wavelength having a wavelength within the range of 1520 nm to 1580 nm.
a means for Q-switching at said first wavelength;
a means for wavelength selection at said first wavelength and;
an intra-cavity frequency doubling means for nonlinear optical interaction with intra-cavity laser radiation at said first wavelength to generate optical coherent radiation at a second wavelength in the range of 760 nm to 790 nm which is the second harmonic of said first wavelength.

2. The system of claim 1 wherein said optical resonant cavity further comprising a means for polarization mode selection at said first wavelength.

3. The system of claim 2 wherein said means for Q-switching, laser wavelength and polarization mode selection is a Fabry-Perot Etalon made of a polarization dependent saturable absorber with absorption coefficient at said first wavelength inversely proportional to the laser intensity inside said optical resonant cavity.

4. The system of claim 2 wherein said frequency doubling means is a wedged frequency doubling crystal that also provides polarization selection function.

5. The system of claim 4 wherein said wedged frequency doubling crystal shifts the frequency of two orthogonal polarized cavity modes by at least 25% of a Free Spectral Range of said cavity.

6. The system of claim 2 wherein said means for Laser wavelength and polarization mode selection is a birefringence Fabry-Perot Etalon which transmission peaks of two orthogonal polarized laser beams are shifted by at least 25% of a Free Spectral Range of said Fabry-Perot Etalon.

7. The system of claim 1 wherein said gain medium comprising Erbium ions as a dopant whereas said first wavelength corresponding to ⁴I_{13/2} to ⁴I_{15/2} laser transition in Er³⁺ (Erbium) active ion within the range of 1520 nm to 1580 nm.

8. The system of claim 1 wherein said pump laser is a diode laser.

9. A Single-Longitudinal-Mode (SLM) Q-Switched intra-cavity frequency doubled laser cavity comprising:
an optical feedback means for resonance.
a gain medium for laser radiation at a first wavelength having a wavelength within the range of 1520 nm to 1580 nm;
a means for Q-switching at said first wavelength;
a means for wavelength selection at said first wavelength and;
an intra-cavity frequency doubling means for nonlinear optical interaction with intra-cavity laser radiation at said first wavelength to generate optical coherent radiation at a second wavelength in the range of 760 nm to 790 nm which is the second harmonic of said first wavelength.

10. The laser cavity of claim 9 wherein said optical resonant cavity further comprising a means for polarization mode selection at said first wavelength.

11. The laser cavity of claim 10 wherein said means for Q-switching, laser wavelength and polarization mode selection is a Fabry-Perot Etalon made of a polarization dependent saturable absorber with absorption coefficient at said first wavelength inversely proportional to the laser intensity inside said optical resonant cavity.

12. The laser cavity of claim 10 wherein said means for Laser wavelength and polarization mode selection is a birefringence Fabry-Perot Etalon which transmission peaks of two orthogonal polarized laser beams are shifted by at least 25% of a Free Spectral Range of said Fabry-Perot Etalon.

13. The laser cavity of claim 10 wherein said frequency doubling means is a wedged frequency doubling crystal that also provides polarization selection function.

14. The laser cavity of claim 9 wherein said optical feedback means comprising at least one reflective mirror with sharp edge spectrum response.

15. The laser cavity of claim 14 wherein said reflective mirror is a thin film filter with at least one sharp edge on spectrum response of reflection which reflectivity changes at least by 5% within a span of 5 nm in a wavelength range from 1520 nm to 1580 nm.

16. An optical component for laser wavelength and polarization mode selection and Q-switching inside a laser cavity comprising a saturable absorber with absorption coefficient inversely proportional to an intensity of said laser beam inside said laser cavity at a wavelength ranging from 1520 to 1580 nm, said optical component further comprising a Fabry-Perot Etalon for laser wavelength and polarization mode selection.

17. The optical component in claim 16 is an Fabry-Perot Etalon made of a polarization dependent saturable absorber with absorption coefficient inversely proportional to an intensity of said laser beam inside said laser cavity at a wavelength ranging from 1520 to 1580 nm.

18. The optical component in claim 16 wherein said Fabry-Perot Etalon is made of a birefringence phase retardation plate which the transmission peaks of two orthogonal polarized laser beams are shifted by at least 25% of a Free Spectral Range of said Fabry-Perot Etalon.
